(19) United States
(12) Patent Application Publication
(10) Pub. No.: US 2010/0088006 A1
(43) Pub. Date: Apr. 8, 2010

(54) FUEL INJECTION APPARATUS

(75) Inventors: Masaharu Ito, Okazaki-city (JP); Yoshiharu Nonoyama, Obu-city (JP); Jun Kondo, Nagoya-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 12/574,858

(22) Filed: Oct. 7, 2009

(30) Foreign Application Priority Data
Oct. 8, 2008 (JP) 2008-261640

(51) Int. Cl. F02D 41/30; F02M 69/46

(52) U.S. Cl. 701/103; 123/456

(57) ABSTRACT

A fuel injection apparatus for an engine includes a fuel pump, a common rail, a fuel injection valve, and a pressure detector. The pressure detector detects pressure of fuel as actual fuel pressure. The apparatus compares the actual fuel pressure with target fuel pressure determined based on an operational state of the engine. The apparatus computes at least one of a lift amount, by which a nozzle needle of the valve is displaced from a valve seat of the valve, and a lifting speed, at which the nozzle needle is displaced from the valve seat, to be smaller with an increase of a difference between the target and actual fuel pressures when the actual fuel pressure is greater than the target fuel pressure. The apparatus applies the drive pulse to the drive unit based on the at least one of the lift amount and the lifting speed.

### CROSS REFERENCE TO RELATED APPLICATION

This application is based on and incorporates herein by reference Japanese Patent Application No. 2008-261640 filed on Oct. 8, 2008.

### BACKGROUND OF THE INVENTION

1. Field of the Invention

The present invention relates to a fuel injection apparatus for injecting fuel supplied from a common rail into a cylinder of an internal combustion engine. For example, the common rail accumulates fuel pumped by the fuel supply pump, and a fuel injection valve injects the high pressure fuel into the cylinder.

2. Description of Related Art

A conventional fuel injection apparatus having a common rail computes target fuel pressure in a common rail based on an operational state of an internal combustion engine, such as a rotational speed, a load. The target fuel pressure serves as a control target, and an amount of fuel discharged from a fuel supply pump is controlled. In the above fuel injection apparatus, for example, when a driver releases an accelerator pedal in order to quickly decelerate the internal combustion engine, a fuel injection quantity computed as the control target becomes zero, and thereby fuel injection from a fuel injection valve (hereinafter referred as an injector) is prohibited. When the driver depresses the accelerator pedal to accelerate the internal combustion engine, the fuel injection quantity and the fuel injection timing is determined in accordance with the operational state at the time, and thereby fuel injection through the injector is restarted.

However, pressure of fuel in the common rail at a time of restarting the fuel injection has not been substantially reduced due to the prohibition of the fuel injection caused by the quick deceleration. As a result, the fuel pressure in the common rail may be kept at the target fuel pressure determined before the deceleration. Thus, actual fuel pressure tends to become greater than the target fuel pressure at a time of restarting the fuel injection, and thereby fuel may be excessively injected within a short period of time disadvantageously when an injection orifice of the injector is reopened. When fuel is excessively injected into the cylinder within a short period of time, a combustion speed of the internal combustion engine is excessively accelerated, and thereby combustion noise of the internal combustion engine may be generated, and furthermore, acceleration shock caused by the excessive acceleration may be generated disadvantageously to a vehicle having the internal combustion engine,

In order to address the above disadvantages, in JP-A-2004-11448, the common rail is provided with a pressure-reducing adjustment valve (pressure regulator) such that fuel pressure in the common rail is reduced to the target fuel pressure.

Also, in JP-A-H11-173192, a solenoid valve is actuated within a time period shorter than a time that is required by a nozzle needle of the injector to open the injection orifice such that high pressure fuel is released to a lower-pressure part. In the above non-injection operation, fuel is not injected. As a result, pressure of fuel supplied to the injector is reduced to the target fuel pressure.

However, the provision of the pressure-reducing adjustment valve to the common rail as above increases a manufacturing cost. Also, in the non-injection operation, the solenoid valve is required to be actuated quickly within a short period of time, and thereby a drive electric current may fall short due to capacity limitation of the drive circuit. As a result, fuel pressure may not be quickly reduced disadvantageously.

### SUMMARY OF THE INVENTION

The present invention is made in view of the above disadvantages. Thus, it is an objective of the present invention to address at least one of the above disadvantages.

To achieve the objective of the present invention, there is provided a fuel injection apparatus for an internal combustion engine, which apparatus includes a fuel pump, a common rail, a fuel injection valve, a pressure detector, comparison means, computation means, and drive means. The fuel pump is adapted to discharge fuel. The common rail is adapted to accumulate fuel discharged from the fuel pump. The fuel injection valve is adapted to inject fuel supplied from the common rail into a cylinder of the engine, and the fuel injection valve includes a nozzle body, a nozzle needle, and a drive unit. The nozzle body has an injection orifice and a valve seat. The nozzle needle is received within the nozzle body. The nozzle needle is engageable with and disengageable from the valve seat such that the nozzle needle closes and opens the injection orifice. The drive unit is adapted to reciprocably displace the nozzle needle in a longitudinal direction of the fuel injection valve in accordance with a drive pulse that is applied to the drive unit. The pressure detector is adapted to detect pressure of fuel as actual fuel pressure, which fuel is supplied from the common rail to the fuel injection valve. The comparison means compares the actual fuel pressure detected by the pressure detector with target fuel pressure that is determined based on an operational state of the internal combustion engine. The computation means computes at least one of a lift amount, by which the nozzle needle is displaced from the valve seat, and a lifting speed, at which the nozzle needle is displaced from the valve seat, to be smaller with an increase of a pressure difference between the target fuel pressure and the actual fuel pressure when the comparison means determines that the actual fuel pressure is greater than the target fuel pressure as a comparison result. The drive means applies the drive pulse to the drive unit based on the at least one of the lift amount and the lifting speed computed by the computation means.

### BRIEF DESCRIPTION OF THE DRAWINGS

The invention, together with additional objectives, features and advantages thereof, will be best understood from the following description, the appended claims and the accompanying drawings in which:

FIG. 1 is a schematic configuration of a fuel injection apparatus for an engine according to a first embodiment of the present invention;

FIG. 2 is a cross-sectional view of an injector according to the first embodiment of the present invention;

FIG. 3 is a cross-sectional view of a part of the injector according to the first embodiment of the present invention;

FIG. 4 is a flow chart of injection control according to the first embodiment of the present invention;

FIG. 5 is a diagram illustrating a relation between injection time and an injection rate according to the first embodiment of the present invention;

FIG. 6 is a diagram illustrating another relation between the injection time and the injection rate according to the first embodiment of the present invention;

FIG. 7 is a flow chart of injection control according to a second embodiment of the present invention;

FIG. 8 is a diagram illustrating a relation between injection time and an injection rate according to the second embodiment of the present invention;

FIG. 9 is a flow chart of injection control according to a third embodiment of the present invention; and

FIG. 10 is a diagram illustrating a relation between injection time and an injection rate according to the third embodiment of the present invention.

### DETAILED DESCRIPTION OF PREFERRED EMBODIMENTS

Embodiments of the present invention will be described with reference to accompanying drawings.

### First Embodiment

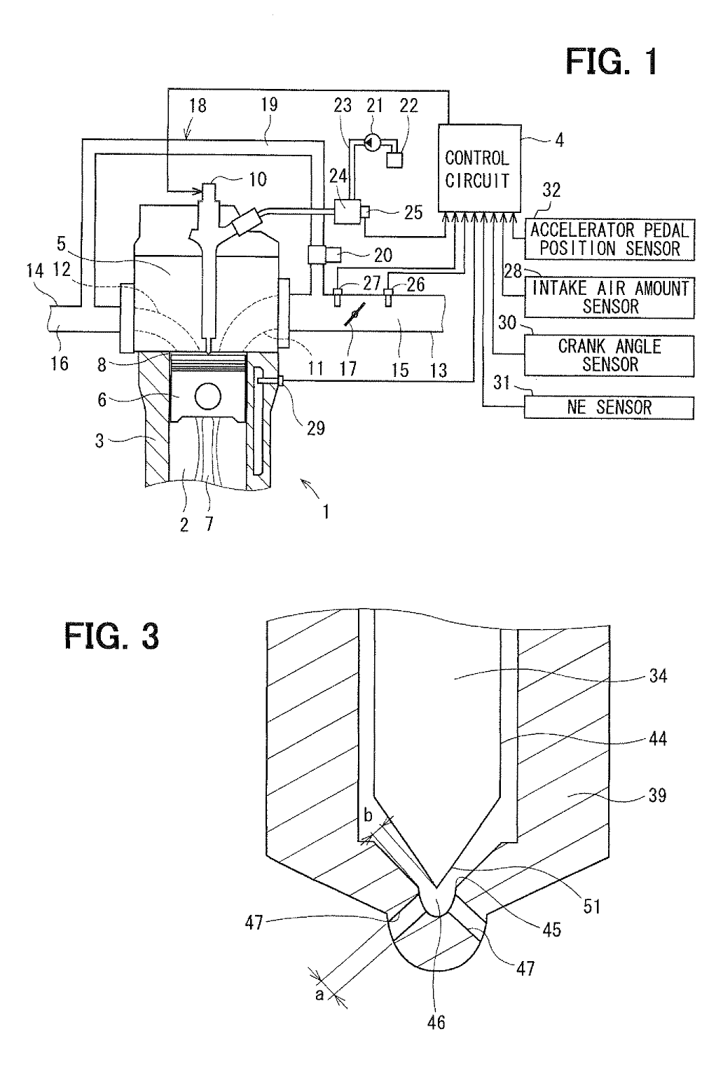

FIG. 1 shows a schematic configuration of a fuel injection apparatus for a diesel internal combustion engine of the first embodiment of the present invention. An engine 1 has a cylinder block 3 and a cylinder head 5. The cylinder block 3 defines therein multiple tubular cylinders 2, and the cylinder head 5 is provided at an end of the cylinder block 3. Each of the cylinders 2 reciprocably receives therein a piston 6. The piston 6 is connected with a crankshaft (not show), which serves as an output shaft of the engine 1, through a connecting rod 7.

Each cylinder 2 defines therein a combustion chamber 8 positioned adjacent to the cylinder head 5. More specifically, the combustion chamber 8 is defined by an inner wall of the cylinder block 3, an inner wall of the cylinder head 5 adjacent to the piston 6, an end portion of the piston 6 adjacent to the cylinder head 5. The cylinder head 5 has an intake port 11 and an exhaust port 12. The intake port 11 and the exhaust port 12 are each communicated with the combustion chamber 8. Each of the intake port 11 and the exhaust port 12 of the cylinder head 5 is connected with an intake pipe 13 and an exhaust pipe 14, respectively. Thus, an intake passage 15 inside the intake pipe 13 is communicated with the combustion chamber 8 through the intake port 11, and an exhaust passage 16 of the exhaust pipe 14 is communicated with the combustion chamber 8 through the exhaust port 12. The intake passage 15 is provided with a throttle valve 17 such that an amount of intake air flowing into the combustion chamber 8 is adjusted.

The intake pipe 13 and the exhaust pipe 14 are connected with an EGR apparatus 18. The EGR apparatus 18 is provided with an EGR passage 19 that provides connection between the intake passage 15 and the exhaust passage 16 to bypass the combustion chamber 8 and to circulate EGR gas, which flows through the exhaust passage 16, to the intake passage 15. The EGR apparatus 18 is provided with an EGR valve 20 that opens and closes the EGR passage 19 such that a flow amount of EGR gas is controlled.

A high-pressure pump 21 serves as a fuel pump. The high-pressure pump 21 suctions fuel stored in a fuel tank 22 through a low-pressure pump (not shown) based on a control command from a control circuit 4, and then, the high-pressure pump 21 pressurizes the suctioned fuel. The high-pressure pump 21 discharges the pressurized fuel under high pressure to a common rail 24, which serves as an accumulation piping through a supply piping 23. The common rail 24 accumulates high pressure fuel discharged from the high-pressure pump 21.

The cylinder head 5 is provided with injectors 10, each of which is associated with the respective cylinder 2. The injector 10 has an end portion toward the injection orifice, and the end portion is exposed to an interior of the combustion chamber 8. Each of the injectors 10 is connected with the common rail 24, and injects high pressure fuel supplied from the common rail 24 into the combustion chamber 8 in accordance with a drive pulse applied by the control circuit 4. Configuration of the injector 10 will be described later.

The engine 1 has various sensors for detecting an operational state. The common rail 24 is provided with a common rail pressure sensor 25 that serves as a pressure detector, and the common rail pressure sensor 25 detects pressure of fuel in the common rail 24 (hereinafter referred to as “common rail pressure”). In the above configuration, the detected common rail pressure is generally equivalent to pressure of fuel supplied from the common rail 24 to the injector 10.

The intake pipe 13 is provided with an intake air sensor 26 and an intake manifold internal pressure sensor 27. The intake air sensor 26 detects temperature of intake air that flows through the intake passage 15, and the intake manifold internal pressure sensor 27 detects pressure of the intake air. An intake air amount sensor 28 detects an amount of intake air that is introduced into the cylinder 2. The cylinder block 3 has a coolant path, through which coolant flows. The coolant path is provided with a coolant temperature sensor 29 that detects the temperature of the coolant.

A crank angle sensor 30 and an NE sensor 31 are provided around a crankshaft. The crank angle sensor 30 and the NE sensor 31 output pulse signals at predetermined angle rotations of the crankshaft for detecting the crank angle and the engine rotational speed, respectively. An accelerator pedal position sensor 32 is provided to an accelerator pedal apparatus (not shown), and is adapted to detect an amount, by which a driver depresses an accelerator pedal.

The control circuit 4 has a microcomputer, which includes a CPU and a memory, such as a ROM, a RAM. The control circuit 4 receives detection signals detected by the above various sensors, and the CPU executes calculation processes based on the detection signals in accordance with control programs and control maps stored in the ROM. The RAM temporarily stores the above computation results. The control circuit 4 detects the operational state of the engine 1 by the calculation process, and controls the drive pulse applied to the drive unit of the injector 10. As above, the control circuit 4 corresponds to “comparison means”, “computation means” and “drive means”.

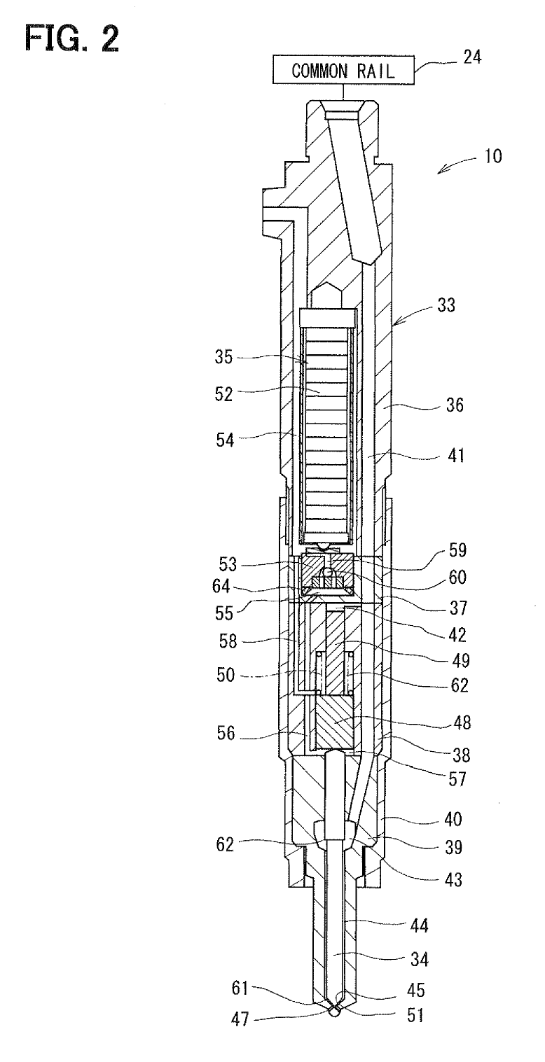

The configuration of the injector 10 will be described with reference to FIGS. 2 and 3. The injector 10 includes a body 33, a nozzle needle 34, and a drive unit 35.

The body 33 has a first body 36, a second body 37, a third body 38, and a nozzle body 39 that are serially connected with each other in the above order. The first body 36 has a generally hollow cylindrical shape, and the first body 36, the second body 37, the third body 38, and the nozzle body 39 are fastened by a retaining nut 40. The body 33 defines therein a high-pressure passage 41, a first back-pressure chamber 42, a fuel chamber 43, and a fuel passage 44. The high-pressure passage 41 is supplied with high pressure fuel from the common rail 24, and the high-pressure passage 41 is communicated with the first back-pressure chamber 42, the fuel chamber 43, and the fuel passage 44. The nozzle body 39 has a valve seat 45 that is located on an internal wall surface of the nozzle body 39, which surface also defines the fuel passage 44. Also, the nozzle body 39 defines a suction chamber 46 at a proximal side of the valve seat 45 (see FIG. 3). The nozzle body 39 has multiple injection orifices 47 at the proximal end of the nozzle body 39, and the injection orifices 47 provides communication between an interior and exterior of the suction chamber 46.

The body 33 receives therein the nozzle needle 34, a needle stopper 48, and a balance piston 49 in this order from the proximal end to the distal end of the injector 10. In other words, the nozzle needle 34, the needle stopper 48, and the balance piston 49 are received within the body 33 in this order in a direction from the injection orifice 47 to the drive unit 35. The nozzle needle 34 has a generally cylindrical column shape. The nozzle needle 34, the needle stopper 48, and the balance piston 49 are fluid-tightly slidable on the inner wall of the body 33, and are displaceable in a longitudinal direction of the injector 10.

A second back-pressure chamber 62 is defined on the distal side of the needle stopper 48 opposite from the injection orifice 47. The second back-pressure chamber 62 receives therein a first spring 50 that urges the needle stopper 48 and the nozzle needle 34 toward the injection orifice 47 (toward the proximal side). The balance piston 49 is urged toward the injection orifice 47 by high pressure fuel supplied by the first back-pressure chamber 42. The nozzle needle 34 has a seat portion 51 at the proximal end of the nozzle needle 34. The seat portion 51 has a conical shape as shown in FIG. 3, and is engageable with and disengageable from the valve seat 45. The nozzle needle 34 regulates flow of fuel between the fuel passage 44 and the suction chamber 46, and opens and closes the injection orifices 47.

The drive unit 35 includes a piezoactuator 52 and a piezo-actuated piston 53. The piezoactuator 52 includes multiple piezo elements that are laminated on one another, and is received within a low pressure chamber 54 defined in the first body 36. The low pressure chamber 54 is communicated with the fuel tank 22 serving as a lower pressure part. Low-pressure fuel supplied to the low pressure chamber 54 is supplied to the second back-pressure chamber 62 through a low-pressure passage 58.

A first pressure chamber 55 is defined at the proximal side of the piezo-actuated piston 53 toward the injection orifice 47. The first pressure chamber 55 receives therein a second spring 64 that urges the piezo-actuated piston 53 and the piezoactuator 52 in a direction away from the injection orifice 47 (toward the distal end of the injector 10).

The piezo-actuated piston 53 defines therein a communication passage 59 that provides communication between the first pressure chamber 55 and the low pressure chamber 54. The communication passage 59 is provided with a check valve 60, which allows fuel to flow from the low pressure chamber 54 to the first pressure chamber 55, and which prohibits the flow of fuel from the first pressure chamber 55 toward the low pressure chamber 54.

A second pressure chamber 57 is defined on a proximal side of the needle stopper 48. The first pressure chamber 55 is communicated with the second pressure chamber 57 through a pressure passage 56. Thus, when the piezoactuator 52 expands, and thereby the piezo-actuated piston 53 is displaced toward the injection orifice 47, pressure of fuel in the second pressure chamber 57 is applied to a proximal end surface of the needle stopper 48, which surface faces toward the injection orifice 47.

Next, an operation of the injector 10 will be described.

When the piezoactuator 52 is not charged, the piezoactuator 52 contracts. At this time, for example, fuel pressure in the first back-pressure chamber 42 has a force (F1) that is applied to a distal end portion of the balance piston 49 opposite the injection orifice. Also the first spring 50 has a biasing force (F2). Fuel pressure in the fuel chamber 43 and the fuel passage 44 have a force (F3) that is applied to surfaces 61, 62 of the nozzle needle 34, which surfaces face toward the injection orifice 47. Also, fuel pressure in the second pressure chamber 57 has a force (F4) that is applied to the other end portion of the needle stopper 48 toward injection orifice 47. When the piezoactuator 52 is not charged, the resultant force of the force (F1) and the force (F2) both applied in the direction toward the injection orifice 47 is greater than the resultant force of the force (F3) and the force (F4) both applied in the opposite direction away from the injection orifice 47. As a result, the seat portion 51 of the nozzle needle 34 is brought to be seated on the valve seat 45, and thereby the communication between the fuel passage 44 and the suction chamber 46 is closed or prohibited. Thereby, fuel injection through the injection orifices 47 is stopped.

When the drive pulse is applied to the piezoactuator 52 from the control circuit 4, and thereby the charge of the piezoactuator 52 is started, the piezoactuator 52 expands in the longitudinal direction in accordance with the amount of the charge. Thus, the piezo-actuated piston 53 is displaced toward the injection orifice 47, and thereby the volume of the first pressure chamber 55 is reduced. Because fuel flow between the first pressure chamber 55 and the low pressure chamber 54 is regulated by the check valve 60, fuel pressure in the second pressure chamber 57 that is communicated with the first pressure chamber 55 through the pressure passage 56 is increased. When the resultant force of the force (F4) and the force (F3) becomes greater than the resultant force of the force (F1) and the biasing force (F2), the nozzle needle 34, the needle stopper 48, and the balance piston 49 are displaced in the direction away from the injection orifice 47. When the seat portion 51 of the nozzle needle 34 is disengaged from the valve seat 45, the fuel passage 44 is communicated with the suction chamber 46, and thereby fuel is injected through the injection orifice 47.

When discharge of the piezoactuator 52 is started by the command of the control circuit 4, the piezoactuator 52 contracts in the longitudinal direction. As a result, fuel pressure in the first pressure chamber 55 and fuel pressure in the second pressure chamber 57 that communicated with the first pressure chamber 55 are reduced. When the resultant force of the force (F1) and the biasing force (F2) again becomes greater than the resultant force of the force (F3) and the force (F4), the nozzle needle 34, the needle stopper 48, and the balance piston 49 are displaced toward the injection orifice 47. When the seat portion 51 of the nozzle needle 34 becomes seated on (engaged with) the valve seat 45, the communication between the fuel passage 44 and the suction chamber 46 is prohibited, and thereby fuel injection through the injection orifice 47 is stopped.

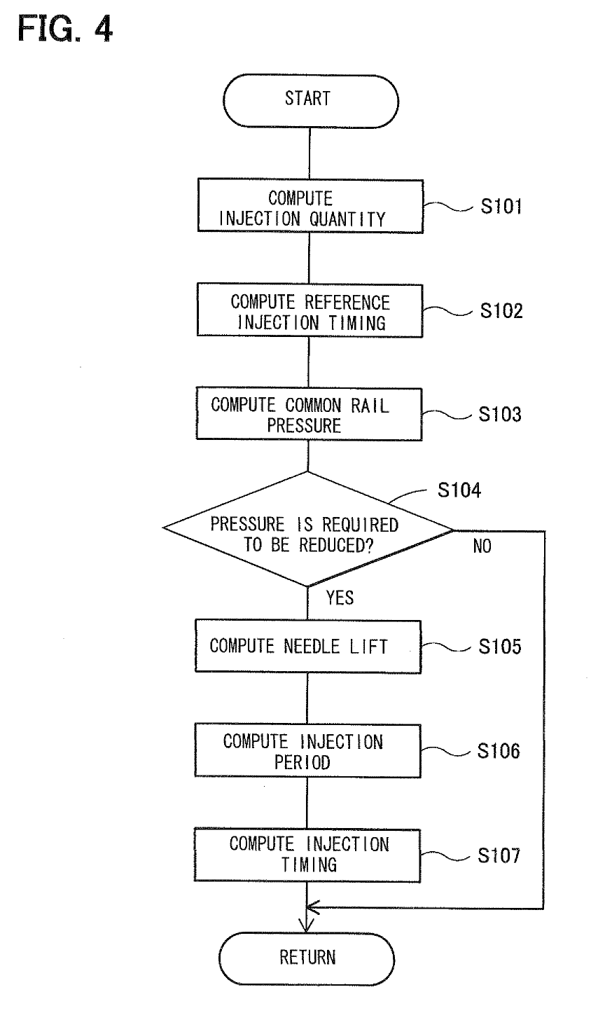

Next, injection control process of the present embodiment will be described with reference to FIG. 4. The flow of the injection control process shown in FIG. 4 is activated at a time of starting the operation of the engine, such as at a time of turning on the ignition key of the vehicle by the driver. Alternatively, the injection control process may be activated when the control circuit 4 receives the detection signal that is detected by the accelerator pedal position sensor 32 during the certain operation of the accelerator pedal, in which the driver releases the accelerator pedal and then depresses the accelerator pedal. It should be noted that the flow of injection control process is ended once after the series of process in FIG. 4 has been executed. However, then, the process is restarted from the beginning.

When the injection control process is activated or started, the control circuit 4 executes step S101 (hereinafter “step” is omitted and “S” indicates “step” instead). At S101, the control circuit 4 computes a fuel injection quantity required for an operational state of the engine 1 based on an accelerator pedal position, which is retrieved from the accelerator pedal position sensor 32, and a rotational speed of the engine, which is retrieved from the NE sensor 31.

Then, control proceeds to S102, in which the control circuit 4 computes reference injection timing, at which fuel injection is executed synchronously with rotation of the engine, based on the fuel injection quantity computed at S101 and based on a crank angle retrieved from the crank angle sensor 30. For example, the control circuit 4 computes timing of starting the drive pulse such that high pressure fuel is injected at timing that corresponds to a position of the piston 6 immediately before a top dead center during the compression stroke.

Then, control proceeds to S103, where the control circuit 4 computes target common rail pressure based on the accelerator pedal position, the rotational speed of the engine, and the control map prestored in the memory. The target common rail pressure serves as a control target that is determined in accordance with the operational state of the engine 1.

Then, control proceeds to S104, where the control circuit 4 serves as comparison means, and the control circuit 4 compares actual common rail pressure, which is retrieved from the common rail pressure sensor 25, with the target common rail pressure computed at S103. When the actual common rail pressure is higher than the target common rail pressure, the comparison means determines that the common rail pressure is required to be reduced (corresponding to YES at S104), and thereby control proceeds to S105. When the actual common rail pressure is equal to or lower than the target common rail pressure (corresponding to NO at S104), control is ended.

At S105, the control circuit 4 serves as computation means, and the control circuit 4 computes a needle lift amount of the nozzle needle 34. The computation means computes the needle lift amount such that the needle lift amount becomes smaller with the increase of a pressure difference between the target common rail pressure and the actual common rail pressure. Then, control proceeds to S 106, where the computation means computes the injection period based on the needle lift amount computed at S105 and based on the injection quantity computed at S101. Then, control proceeds to S107, where the computation means computes injection timing based on the reference injection timing computed at S102 and based on the injection period computed at S106.

The control circuit 4 serves as drive means, and applies the drive pulse, which is based on the computation result computed by computation means in the injection control process, to the piezoactuator 52 of the injector 10.

When it is determined that the pressure is required to be reduced at S104 (corresponding to YES at S104), the drive means stops applying the drive pulse to the piezoactuator 52 at a certain number of times based on the computation result computed by the computation means at S105 to S107. The operational state of the nozzle needle 34 is shown in FIG. 3. The nozzle needle 34 stops under a state, where the lift amount is small. At the above time, a cross sectional area b of the opening defined between the seat portion 51 and the valve seat 45 (hereinafter referred as “passage cross sectional area b”) is equal to or less than a total of cross sectional areas of the openings of the injection orifices 47. The total of the openings of the injection orifices 47 is hereinafter referred as “injection orifice cross sectional area a”. In the above state, an injection rate of fuel injected through the injection orifice 47 is correlated with the common rail pressure and the passage cross sectional area b. It should be noted that the injection rate in the present specification indicates a fuel injection quantity per unit time.

Ii contrast, when the pressure is not required to be reduced at S104 (corresponding to NO at S104), the drive means applies the drive pulse, which is based on the computation result computed at S101 and S102 by the computation means, to the piezoactuator 52. In the above case, the lift of the nozzle needle 34 causes the passage cross sectional area b to become greater than the injection orifice cross sectional area a. In the above state, the injection rate is correlated with the common rail pressure and the injection orifice cross sectional area a.

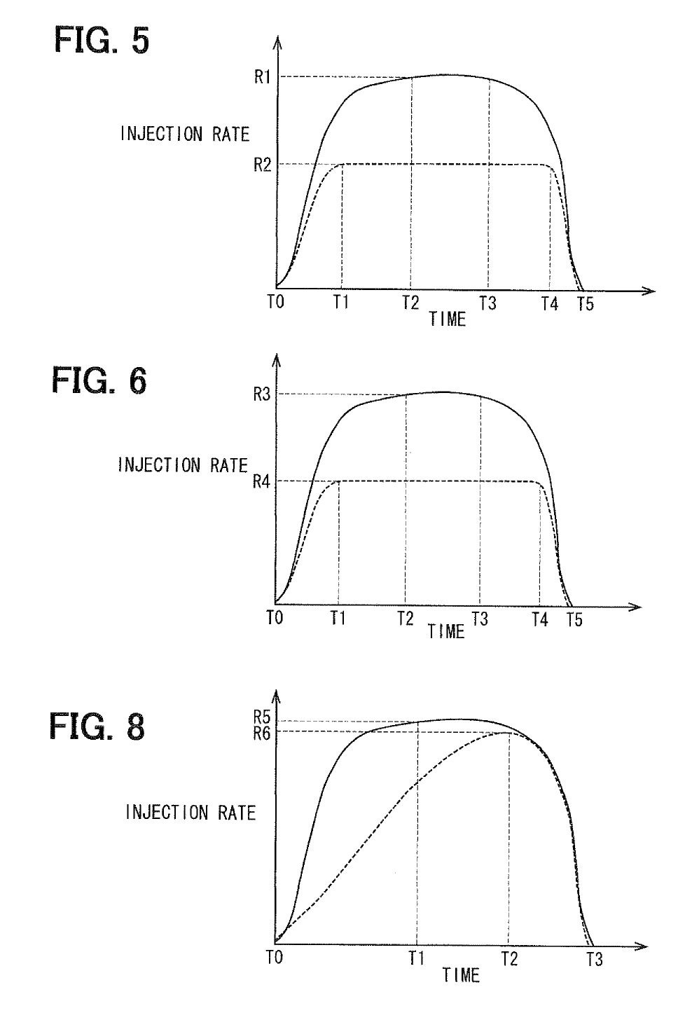

FIG. 5 shows a relation between injection time and the injection rate when the pressure is not required to be reduced at 5104 (corresponding to NO at S104). For example, in FIG. 5, the nozzle needle 34 starts lifting (being disengaged from the valve seat 45) at time T0, and the nozzle needle 34 is again brought into engagement with the valve seat 45 at time T5. In FIG. 5, a solid line indicates the relation between the injection time and the injection rate at a time, where the actual common rail pressure is relatively high. Also, a dotted line indicates the relation between the injection time and the injection rate at a time, where the actual common rail pressure is relatively low.

In a case, where the actual common rail pressure is relatively high, during a time period from time T0 to time T2, the injection rate becomes greater with the increase of the passage cross sectional area b. During another time period from time T2 to time T3, the passage cross sectional area b becomes greater than the injection orifice cross sectional area a. As a result, the injection rate correlates with the common rail pressure and the fixed injection orifice cross sectional area a, and thereby the injection rate generally constantly indicates a peak value R1. During still another time period from time T3 to time T5, the injection rate becomes smaller with the decrease of the passage cross sectional area b. As above, one event of fuel injection is ended. In another case, where the actual common rail pressure is relatively low, during a time period from time T0 to time T1, the injection rate becomes greater with the increase of the passage cross sectional area b. During another time period form time T1 to time T4, the injection rate correlates with the common rail pressure and the injection orifice cross sectional area a, and thereby the injection rate generally constantly indicates a peak value R2. Even in the case, where the injection orifice cross sectional area a indicates a certain common value in the above two cases, the peak value R2 of the injection rate is smaller than the peak value R1 due to the difference of the actual common rail pressure. During a time period from time T4 to time T5, the injection rate becomes smaller with the decrease of the passage cross sectional area b, and the fuel injection is ended.

FIG. 6 shows the relation between the injection time and the injection rate when the pressure is required to be reduced at S104 (corresponding to YES at S104). In FIG. 6, a solid line indicates a relation between the injection time and the injection rate in a comparison example case, where the needle lift amount is large and the passage cross sectional area b is greater than the injection orifice cross sectional area a. In the comparison example, during a time period from time T0 to time T2, the injection rate is sharply increased with the increase of the passage cross sectional area b. During a time period from time T2 to time T3, because the passage cross sectional area b becomes greater than the injection orifice cross sectional area a, the injection rate correlates with the common rail pressure and the injection orifice cross sectional area a, and the injection rate generally constantly indicates a peak value R3. The peak value R3 of the injection rate is greater than an injection rate that is suitable for the operational state of the engine. As a result, atomization of fuel for the injection is excessively enhanced, and thereby the combustion is excessively activated disadvantageously in the comparison example. During a time period from time T3 to time T5, the injection rate becomes smaller with the decrease of the passage cross sectional area b.

In contrast, a dotted line shows another relation between the injection time and the injection rate when the injection control of the present embodiment reduces the needle lift amount such that the passage cross sectional area b to becomes smaller than the injection orifice cross sectional area a. In the present embodiment, the computation means computes the needle lift amount to be relatively smaller at S105 such that the difference between the passage cross sectional area b and the injection orifice cross sectional area a becomes relatively smaller when the pressure difference between the target common rail pressure and the actual common rail pressure is relatively smaller. In contrast, when the pressure difference between the target common rail pressure and the actual common rail pressure is relatively large, the computation means computes the needle lift amount to be relatively greater such that the difference between the passage cross sectional area b and the injection orifice cross sectional area a is relatively large. During a time period from T0 to T1, the nozzle needle 34 lifts to a certain position computed by the computation means at S105, and thereby the injection rate becomes greater with the increase of the passage cross sectional area b. The injection rate is held at the peak value R4 that is suitable for the operational state of the engine. During a time period from T1 to T4, the nozzle needle 34 is maintained at the certain position, and thereby the passage cross sectional area b remains constant. Thus, the injection rate is held constantly at the peak value R4. During a time period from T4 to T5, the injection rate becomes smaller with the decrease of the passage cross sectional area b, and then fuel injection is ended.

In the present embodiment, the comparison means compares the actual fuel pressure detected by the pressure detector with the target fuel pressure determined based on the operational state of the engine. When the actual fuel pressure is higher than the target fuel pressure, the computation means computes the lift amount of the nozzle needle 34 to be smaller with an increase of the pressure difference between the target fuel pressure and the actual fuel pressure. Thus, the drive means applies the drive unit 35 with the drive pulse, which is computed by the computation means based on the computation result such that a cross sectional area of an opening of a fluid passage defined between the injection orifice 47 (nozzle body 39) and the nozzle needle 34. As a result, even when the actual common rail pressure is higher than the target common rail pressure, it is possible to make the peak value of injection rate a value R4 suitable for the operational state. As a result, atomization of fuel is effectively limited, and thereby the excessive activation of the combustion is limited. Thus, combustion noise of the engine and acceleration shock of the vehicle mounted with the engine are effectively limited.

Also, by eliminating the pressure-reducing adjustment valve that adjusts pressure of fuel in the common rail, it is possible to effectively reduce the manufacturing cost of the apparatus. Furthermore, because it is possible to appropriately adjust the injection rate without changing the actual common rail pressure, it is possible to improve the responsivity of the fuel injection apparatus.

### Second Embodiment

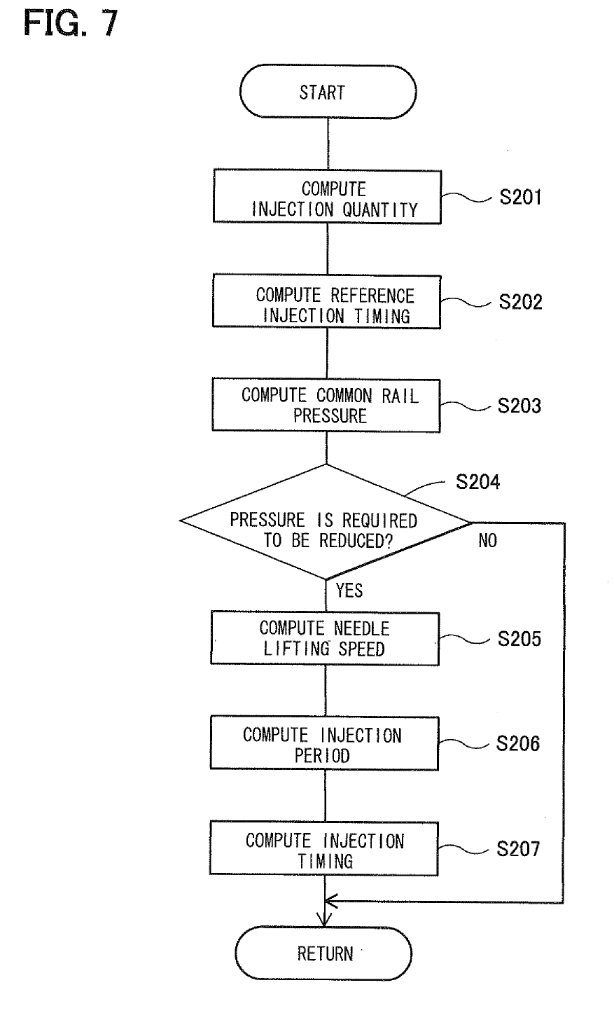

An injection control process of the second embodiment of the present invention will be described with reference to FIG. 7. In FIGS. 7, S201 to S204 and S207 correspond to S101 to S104 and S107 of the first embodiment, and thereby the description thereof will be omitted.

At S205, the control circuit 4 serves as the computation means, and computes a needle lifting speed of the nozzle needle 34, at which speed the needle lifts or is displaced. The computation means computes the needle lifting speed to become smaller with the increase of the pressure difference between the target common rail pressure and actual common rail pressure. Then, control proceeds to S206, where the computation means computes a injection period based on the injection quantity computed at S201 and based on the needle lifting speed computed at S205.

The control circuit 4 serves as drive means, and applies the drive pulse, which is determined based on the computation result computed by the computation means, to the piezoactuator 52 of the injector 10.

When the pressure is required to be reduced at S204 (corresponding to YES at S204), the drive means reduces the voltage of the drive pulse applied to the piezoactuator 52 based on the computation result computed by the computation means at S205 to S207. At this time, because the charge speed for charging the piezoactuator becomes slower, the lifting speed for lifting the nozzle needle becomes lower. Thus, the passage cross sectional area b gradually increases.

FIG. 8 shows a relation between the injection time and the injection rate in a case, where the pressure is required to be reduced at S204 (corresponding to YES at S204). In FIG. 8, a solid line shows a relation between the injection time and the injection rate of a comparison example, where the needle lift speed is large and the passage cross sectional area b becomes larger than the injection orifice cross sectional area a. During a time period from T0 to T1, the injection rate sharply increases with the increase of the passage cross sectional area b. During a time period from T1 to T2, because the passage cross sectional area b becomes greater than the injection orifice cross sectional area a, the injection rate correlates with the common rail pressure and the injection orifice cross sectional area a, and the injection rate generally constantly indicates a peak value R5. The peak value R5 of injection rate is greater than an injection rate that is suitable for the operational state of the engine. Thus, the atomization of fuel in the injection is excessively enhanced, and thereby the combustion is excessively activated. During a time period from T2 to T3, the injection rate is reduced with the decrease of the passage cross sectional area b. The fuel injection quantity during one event of the injection period becomes greater than the fuel injection quantity computed at S201 disadvantageously.

In contrast, a dotted line shows a relation between the injection time and the injection rate when the injection control of the present embodiment reduces the needle lifting speed such that the passage cross sectional area b gradually increases. During a time period from T0 to T2, the nozzle needle operates at a certain lift speed computed at S205. Thus, the injection rate is increased with the increase of the passage cross sectional area b. However, a time period from T0 to T2, by which the injection rate reaches a peak value R6, is longer than a time period from T0 to T1, by which the injection rate of the comparison example reaches the peak value R5. During a time period from T2 to T3, the injection rate is reduced with the decrease of the passage cross sectional area b, and the fuel injection is ended.

In the present embodiment, the computation means computes the lifting speed of the nozzle needle 34 to become smaller with the increase of the pressure difference between the target fuel pressure and the actual fuel pressure. As a result, the control circuit 4 controls the drive pulse which is applied to the drive unit 35, based on the computation result computed by the computation means. As a result, the cross sectional area of the opening of the fluid passage defined between the injection orifice 47 (the nozzle body 39) and the nozzle needle 34 at the initial stage of the injection is effectively reduced.

As above, it is possible to reduce the injection rate at the initial stage of the injection by reducing the lifting speed of the nozzle needle even when the actual common rail pressure is higher than the target common rail pressure. As a result, it is possible to limit the atomization of fuel at the initial stage of the injection, and thereby the combustion speed is limited from being excessively increased. As a result, the combustion noise of the engine and the acceleration shock of the vehicle mounted with the engine is effectively limited.

### Third Embodiment

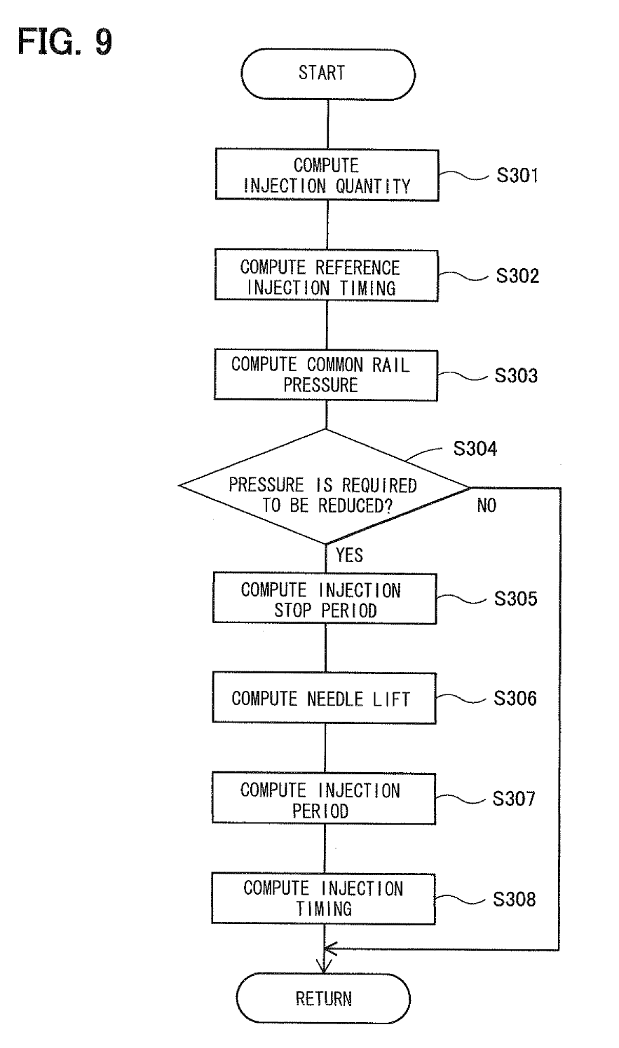

An injection control process of the third embodiment of the present invention will be described with reference to FIG. 9. In FIGS. 9, S301 to S304 and S308 correspond to S101 to S104 and S107 of the first embodiment, respectively, and thereby the description thereof will be omitted.

At S305, the computation means computes an injection stop period, fuel injection through the injector is stopped, based on information related to the accelerator pedal position, which is retrieved from the accelerator pedal position sensor. Then, control proceeds to S306, where the computation means corrects the needle lift amount, which is computed based on the pressure difference between the target common rail pressure and the actual common rail pressure, to become smaller if the injection stop period is shorter than a predetermined time period such that the injection rate becomes appropriate to the operational state of engine.

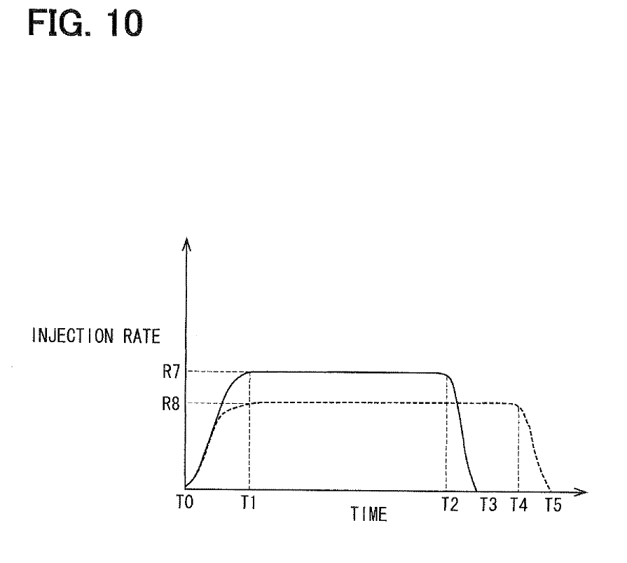

FIG. 10 shows a relation between the injection time and the injection rate in a case, where the pressure is required to be reduced at S304 (corresponding to YES at S304). In FIG. 10, a solid line indicates a relation between the injection time and the injection rate in a case, where the injection stop period is longer than the predetermined time period. Also, a dotted line indicates another relation between the injection time and the injection rate in another case, where the injection stop period is shorter than the predetermined time period.

When the injection stop period is longer than the predetermined time period, during a time period from T0 to T1, the nozzle needle is lifted to a certain position, which is computed based on the pressure difference between the target common rail pressure and the actual common rail pressure at S306. Thus, the injection rate becomes larger with the increase of the passage cross sectional area b. The injection rate is held at a peak value R7 of the injection rate, which value is suitable for the operational state of engine. During a time period from T1 to T2, the injection rate is held at the peak value R7. During a time period from T2 to T3, the injection rate becomes smaller with the decrease of the passage cross sectional area b, and the fuel injection is ended. Fuel of the fuel injection quantity, which is computed at S301, is injected during the injection period from time T0 to time T3 computed at S307.

Although the rotational speed of the engine has been reduced when the injection stop period is made shorter than the predetermined time period, temperature in the cylinder usually is held at a temperature in the cylinder before stopping of the injection. As a result, actual temperature is higher than a target temperature in the cylinder. Thus, at S306, the computation means corrects the needle lift amount, which is computed based on the pressure difference between the target common rail pressure and the actual common rail pressure, to become smaller such that the combustion is limited from excessively activated.

During a time period from T0 to T1, the nozzle needle is lifted (is displaced) to a certain position computed at S306, and the injection rate is held at a peak value R8 that is suitable for the operational state of the engine. During a time period from T1 to T4, the injection rate is held at the peak value R8. During a time period from T4 to T5, the injection rate becomes smaller with the decrease of the passage cross sectional area b, and the fuel injection is ended. Fuel of the fuel injection quantity, which is computed at S301, is injected during an injection period from time T0 to time T5 computed at S307.

In the present embodiment, the computation means computes the injection stop period, during which fuel injection through the injector is stopped, and the computation means corrects the lift amount of the nozzle needle, which is computed based on the pressure difference between the target common rail pressure and the actual common rail pressure, such that the injection rate becomes more suitable for the operational state of the engine. When the injection stop period is shorter than the predetermined value temperature in the cylinder may be higher than the target temperature in the cylinder. As a result, the fuel injection of the injection rate, which is caused by the computed lift amount, may result in the excessive combustion. In order to address the above, in the preset embodiment, the computation means corrects the lift amount the nozzle needle such that the injection rate becomes suitable for the operational state of the engine. Thus, it is possible to highly accurately control the injection rate, and thereby it is possible to improve the accuracy in the fuel injection control.

### Other Embodiment

In the above embodiments, the computation means computes the needle lift amount or the needle lifting speed. In general, because the injection period falls within a certain range, when the target fuel injection quantity becomes greater than a predetermined quantity, the injection rate becomes greater from the initial stage of the injection. As a result, the combustion speed of the internal combustion engine may excessively increased. In general, the combustion speed of the internal combustion engine relates to the injection rate at the initial stage of the injection. Thus, when the target fuel injection quantity is smaller than the predetermined quantity, the lift amount of the nozzle needle is computed to be smaller such that the injection rate is made appropriate during the injection period. In contrast, when the target fuel injection quantity is greater than the predetermined amount, the lifting speed of the nozzle needle is computed to be relatively smaller such that the injection rate at the initial stage of the injection is reduced.

In the third embodiment, the computation means corrects the needle lift amount in accordance with the injection stop period. Alternatively, the needle lifting speed may be corrected in accordance with the injection stop period.

As above, the present invention is not limited to the above embodiments. The above multiple embodiments may be combined as required to make applicable various embodiments provided that the gist of the invention is not deviated.

Additional advantages and modifications will readily occur to those skilled in the art. The invention in its broader terms is therefore not limited to the specific details, representative apparatus, and illustrative examples shown and described.

What is claimed is:

1. A fuel injection apparatus for an internal combustion engine comprising:
a fuel pump adapted to discharge fuel;
a common rail adapted to accumulate fuel discharged from the fuel pump;
a fuel injection valve adapted to inject fuel supplied from the common rail into a cylinder of the engine, the fuel injection valve including:
a nozzle body having an injection orifice and a valve seat;
a nozzle needle that is received within the nozzle body, the nozzle needle being engageable with and disengageable from the valve seat such that the nozzle needle closes and opens the injection orifice; and
a drive unit adapted to reciprocably displace the nozzle needle in a longitudinal direction of the fuel injection valve in accordance with a drive pulse that is applied to the drive unit;
a pressure detector adapted to detect pressure of fuel as actual fuel pressure, which fuel is supplied from the common rail to the fuel injection valve;
comparison means for comparing the actual fuel pressure detected by the pressure detector with target fuel pressure that is determined based on an operational state of the internal combustion engine;
computation means for computing at least one of (a) a lift amount, by which the nozzle needle is displaced from the valve seat, and (b) a lifting speed, at which the nozzle needle is displaced from the valve seat, to be smaller with an increase of a pressure difference between the target fuel pressure and the actual fuel pressure when the comparison means determines that the actual fuel pressure is greater than the target fuel pressure as a comparison result; and
drive means for applying the drive pulse to the drive unit based on the at least one of the lift amount and the lifting speed computed by the computation means.

2. The fuel injection apparatus according to claim 1, wherein:
the at least one of the lift amount and the lifting speed is the lift amount,

3. The fuel injection apparatus according to claim 2, wherein:
the computation means computes an injection stop period, during which the fuel injection valve stops injecting fuel, based on the operational state of the engine;
when the injection stop period is shorter than a predetermined time period, the computation means corrects the lift amount of the nozzle needle to become smaller such that an injection rate of the fuel injection valve becomes appropriate for the operational state of the engine.

4. The fuel injection apparatus according to claim 3, wherein:
the injection rate is an injection quantity of fuel per unit time, which fuel is injected by the fuel injection valve.

5. The fuel injection apparatus according to claim 1, wherein:
the at least one of the lift amount and the lifting speed is the lifting speed.

6. The fuel injection apparatus according to claim 5, wherein:
the computation means computes an injection stop period, during which the fuel injection valve stops injecting fuel, based on the operational state of the engine;
when the injection stop period is shorter than a predetermined time period, the computation means corrects the lifting speed of the nozzle needle to become smaller such that an injection rate of the fuel injection valve becomes appropriate for the operational state of the engine.

7. The fuel injection apparatus according to claim 6, wherein:
the injection rate is an injection quantity of fuel per unit time, which fuel is injected by the fuel injection valve.

8. The fuel injection apparatus according to claim 1, wherein:
the at least one of the lift amount and the lifting speed includes the lift amount and the lifting speed;
when a target fuel injection quantity is smaller than a predetermined quantity, the computation means computes the lift amount of the nozzle needle to become smaller; and
when the target fuel injection quantity is larger than the predetermined quantity, the computation means computes the lifting speed of the nozzle needle to become relatively smaller.
